(19) United States
(12) Patent Application Publication
(10) Pub. No.: US 2005/0197145 A1
(43) Pub. Date: Sep. 8, 2005

(54) Mobile phone capable of input of phone number without manipulating buttons and method of inputting phone number to the same

(75) Inventors: Kyoung Soo Chae, Suwon (KR); Ghun Hahm, Sungnam (KR); Ho Joon Park, Seoul (KR); Sang Hyun Choi, Seoul (KR); Won Chul Sim, Sungnam (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: SAMSUNG ELECTRO-MECHANICS CO., LTD., Suwon (KR)

(21) Appl. No.: 10/899,037

(22) Filed: Jul. 27, 2004

(30) Foreign Application Priority Data
Mar. 3, 2004 (KR) 2004-14314

(51) Int. Cl. H04Q 7/20

(52) U.S. Cl. 455/517

(57) ABSTRACT

The present invention relates to a mobile phone, which allows a user to input a phone number by simply moving the body of the mobile phone without manipulating the buttons of a key pad, thus providing the user with convenience. The mobile phone includes a vibration/inclination detection means for detecting the numbers and directions of movements of a body of the mobile phone, an interface means for converting the detection signals of the vibration/inclination detection means into signals detectable by a control means and transmitting the signals to the control means, an auxiliary input means, which is placed on an outside of the mobile phone to be easily manipulated, for generating an on or off signal according to the operation of the user, and the control means for receiving the numbers and directions detected by the vibration/inclination detection means, converting the received numbers and directions into successive input numbers according to a predetermined rule, and attempting a call connection using the converted input numbers.

### BACKGROUND OF THE INVENTION

1. Field of the Invention

The present invention relates generally to a mobile phone and, more particularly, to a mobile phone, which allows a user to input a phone number by simply shaking or moving the body of the mobile phone without manipulating the buttons of a key pad, thus providing the user with convenience.

2. Description of the Related Art

Recently, with the rapid development of wireless communication technology and the popularization of mobile phones, mobile phones have become necessities owned by most modern people. As for the mobile phones, there were used regular mobile phones, that is, first generation terminals, which have a shape identical with that of general codeless telephones, there are generalized flip-type mobile phones, that is, second generation terminals, to which openable covers for protecting keypads are attached, and there are recently and mainly used folder-type mobile phones in which speaker devices or displays are placed on the folder parts thereof, thus being capable of realizing small-sized mobile phones.

FIGS. 1a and 1b are perspective views showing a flip-type mobile phone as an example of mobile phones. FIG. 1a shows the mobile phone with a flip being closed, and FIG. 1b shows the mobile phone with the flip being opened.

As shown in the drawings, the mobile phone 100 is formed in such a way that a speaker SPK for outputting a voice signal and a Liquid Crystal Display (LCD) are placed on the upper portion of the body of the mobile phone 100, and a flip 126 combined with the phone body to selectively open and close the phone body around a hinge unit and a microphone MIC for receiving the user's voice are formed on the lower portion of the phone body.

A key input unit 118 including number keys, which ranges from zero to nine keys, and a plurality of function keys, on which special functions, such as a call, types, menus and selection, are set, are formed on the body of the mobile phone 100 covered with the flip 126. Accordingly, the flip 126 is opened to allow the user to manipulate the key input unit 118 at the time of inputting a phone number as shown in FIG. 1b, and the flip 126 is closed to protect the key input unit 118 and prevent an incorrect operation in a standby mode as shown in FIG. 1a.

In the case of the folder-type mobile phone, an LCD and a speaker SPK are formed on a folder that is hinged with the phone body to rotate around a hinge axis, and the key input unit and the microphone MIC are formed on the phone body. The folder-type mobile phone is used in such a way that the folder is opened to allow the user to manipulate the key input unit of the phone body at the time of using the mobile phone and the folder is closed in a standby mode.

The basic electric circuit of a mobile phone is constructed as shown in FIG. 2 regardless of the type of the mobile phone, such as a flip-type and a folder-type. In this case, a duplexer 101 outputs a radio signal, which has been received from an antenna, to a radio reception unit 102, and functions to transmit a transmission signal, which has been output from a radio transmission unit 108, through the antenna. The radio reception unit 102 outputs data to a control unit 112 at the time of receiving the data, and outputs a voice signal to a voice processing unit 104. Additionally, the radio transmission unit 108 outputs a transmission signal, which has been applied from the voice processing unit 104, to the duplexer 101 through a set channel under the control of the control unit 112 at the time of calling. The voice processing unit 104 decodes the signal received from the radio reception unit 102 and outputs the decoded signal to the speaker SPK through a speakerphone unit 107. Additionally, the voice processing unit 104 receives the user's voice, which has been converted into an electric signal by the microphone MIC, thorough the speakerphone 107, encodes the electric signal, and outputs the encoded signal to the radio transmission unit 108. Thereafter, a signal level detection unit 122 detects the intensity of a voice signal received from a transmitting terminal and the intensity of the voice signal of the user of a receiving terminal, and informs the control unit 112 of detection results. A ring signal generation unit 114 generates a ringtone under the control of the control unit 112 at the time of receiving a ring signal. A memory unit 110 includes a Read Only Memory (ROM) for storing control data required for the control operation of the control unit 112, a nonvolatile memory for storing data to be stored or removed by the manipulation of the user, such as phone numbers and schedules, and a Random Access Memory (RAM) for temporarily storing data generated at the time of controlling a program.

With the above described construction, when a user makes a call, a call signal for a phone number input through the key input unit 118 is transmitted under the control of the control unit 112, and a voice call can be accomplished through the duplexer 101, the radio transmission and reception units 112 and 118, the voice processing unit 104 and the speakerphone unit 107 by the answer of a counterpart to the call. In contrast, when a call is received, a ring signal is generated through the ring signal generation unit 114 under the control of the control unit 112 that has received the call signal, and a voice call can be accomplished through the duplexer 101, the radio transmission and reception units 102 and 108, the voice processing unit 104 and the speakerphone unit 107 by the pressing of a call button through the manipulation of the key input unit 118 in response to the ring signal.

As described above, in such a conventional mobile phone, a desirable phone number is input by manipulating the buttons of the key input unit 118 formed on the phone body. However, as the mobile phone becomes smaller, the button sizes of the key input unit 118 become smaller and the gaps between the buttons become narrower.

Accordingly, a person, who has hands bigger than those of an average person, has indisposed hands or puts gloves on, feels considerable difficulty or inconvenience in inputting a phone number by manipulating the key input unit 118 of the mobile phone.

Alternatively, to solve inconvenience in inputting a phone number generally having ten or more digits, there has been added a function of an abbreviated dialing in which a user registers a corresponding phone number as an abbreviated dialing number having three or less digits and a call connection is performed using the registered phone number by the pressing of the abbreviated number. However, the abbreviated dialing function can reduce the number of the buttons of the key input unit 118 that should be pressed, but still has a problem in that the buttons of the key input unit 118 must be manipulated.

Accordingly, an input error may occur in the case where a person, who has hands bigger than those of an average person, has indisposed hands or puts gloves on, manipulates the key input unit 118.

### SUMMARY OF THE INVENTION

Accordingly, the present invention has been made keeping in mind the above problems occurring in the prior art, and an object of the present invention is to provide a mobile phone, which enables a user to input a phone number by simply shaking or moving the body of the mobile phone without manipulating the buttons of a key pad, thus providing the user with convenience.

In order to accomplish the above object, the present invention provides a mobile phone capable of input of phone number without manipulating buttons, including a vibration/inclination detection means for detecting the numbers and directions of movements of a body of the mobile phone, an interface means for converting the detection signals of the vibration/inclination detection means into signals detectable by a control means and transmitting the signals to the control means, an auxiliary input means, which is placed on the outside of the mobile phone to be easily manipulated, for generating an on or off signal according to the operation of the user, and the control means for receiving the numbers and directions detected by the vibration/inclination detection means, converting the received numbers and directions into successive input numbers according to a predetermined rule, and attempting a call connection using the converted input numbers.

The vibration/inclination detection means may be a multi-axes geomagnetic sensor or accelerometer capable of detecting earth magnetism or acceleration in two or more directions.

The control means may set different multiples on directions of movements and inclinations, and set input numbers to values, obtained by multiplying the numbers input through the interface means by set multiples in corresponding directions.

In order to accomplish the above object, the present invention provides a method of inputting a phone number to a mobile phone having a vibration/inclination detection means for detecting movements of a body of the mobile phone and an auxiliary input means placed on an outside of the phone body to allow a user to turn on or off the auxiliary input means, comprising the steps of checking whether the auxiliary input means is turned on or off, receiving the detection signals of the vibration/inclination detection means while the auxiliary input means is turned on, and detecting and storing the number and direction of movements and inclinations of the mobile phone, detecting a state in which there is no movement of the mobile phone during a first set time by counting successive time for which the detection signal is not output from the vibration/inclination detection means and checking whether the successive time reach the first set time, calculating and storing the stored direction and number of the movements and inclinations to an input number according to the predetermined rule if, as a result of the detection, there is no movement of the mobile phone during the set time, and checking whether the auxiliary input means is turned on, and repeating the above-described steps while the auxiliary input means is turned on, and attempting a call connection using stored successive input numbers if the auxiliary input means is turned off.

The method of inputting the phone number to the mobile phone further includes the steps of setting multiples a, b, c and d (in this case, a, b, c and d are integral numbers equal to or larger than zero, and a≠b≈c≈d is satisfied) on directions of the detected movements and inclinations, and calculating the input number N using the following equation if it is assumed that w, x, y and z indicate the numbers of the detected movements and inclinations in upper, lower, left and right directions, respectively.
N=aw+bx+cy+dz

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b are views showing the appearances of flip-type mobile phones;

FIG. 2 is a block diagram showing the electric construction of a conventional mobile phone;

FIG. 3 is a block diagram showing the construction of a mobile phone according to the present invention; and

FIG. 4 is a flowchart showing a process of inputting a phone number to the mobile phone of the present invention;

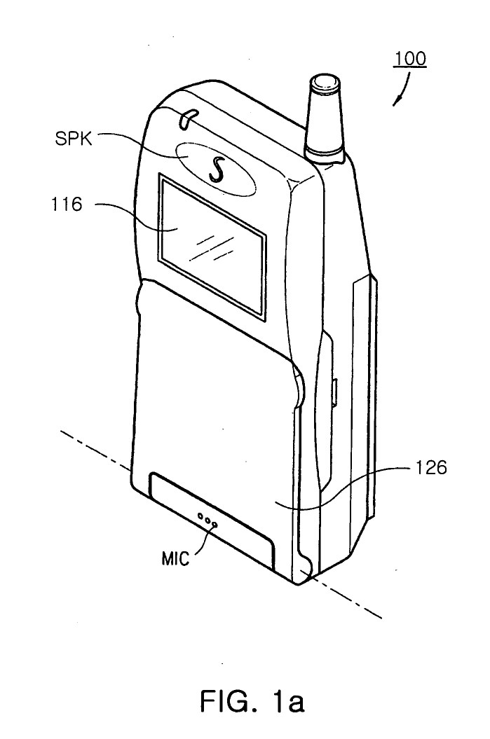

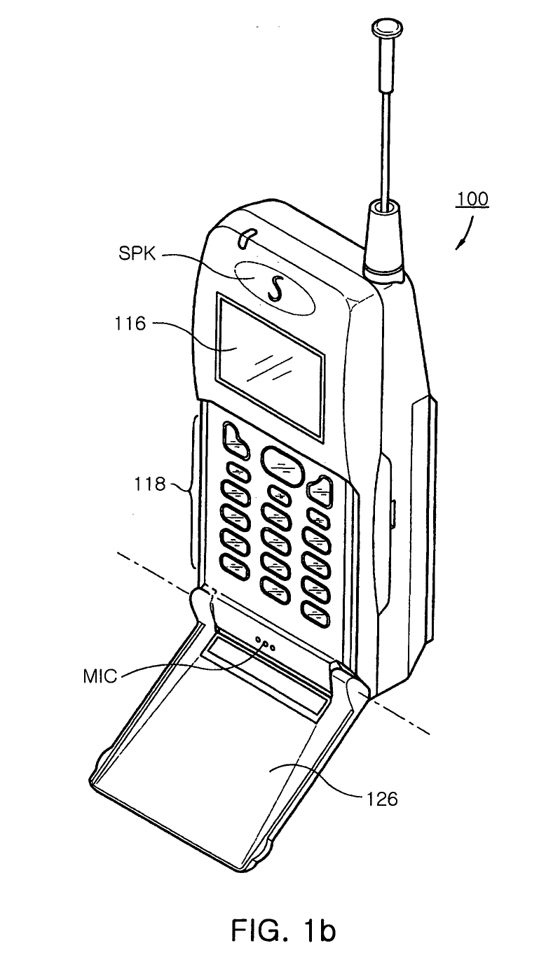

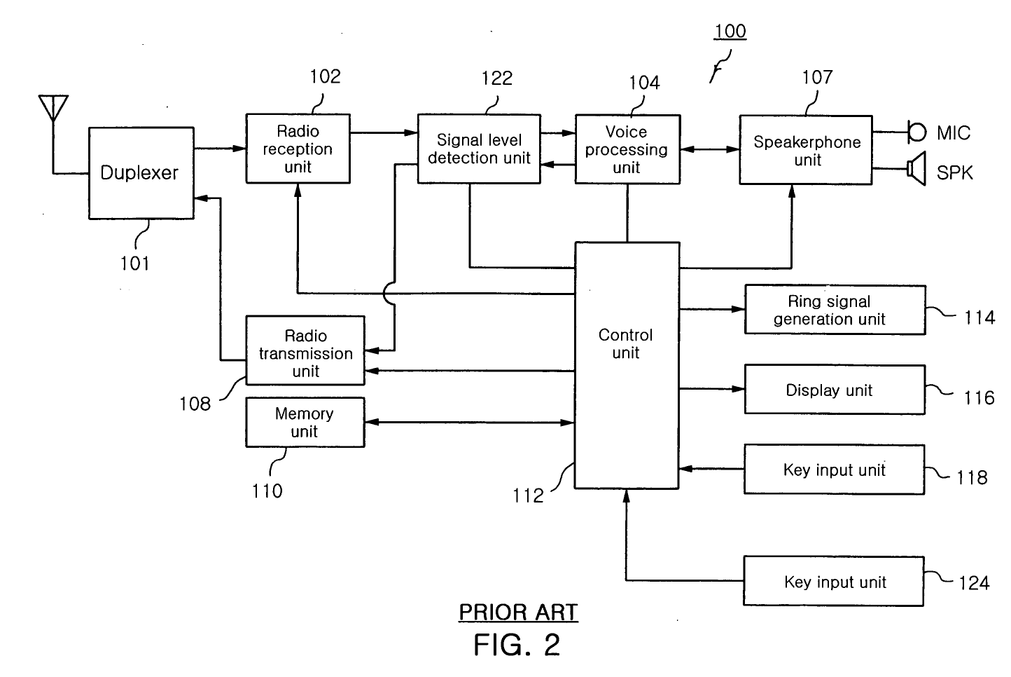

### DESCRIPTION OF THE PREFERRED EMBODIMENTS

Reference now should be made to the drawings, in which the same reference numerals are used throughout the different drawings to designate the same or similar components.

A mobile phone and a method of inputting a phone number to the mobile phone according to the present invention are described in detail with reference to the attached drawings below.

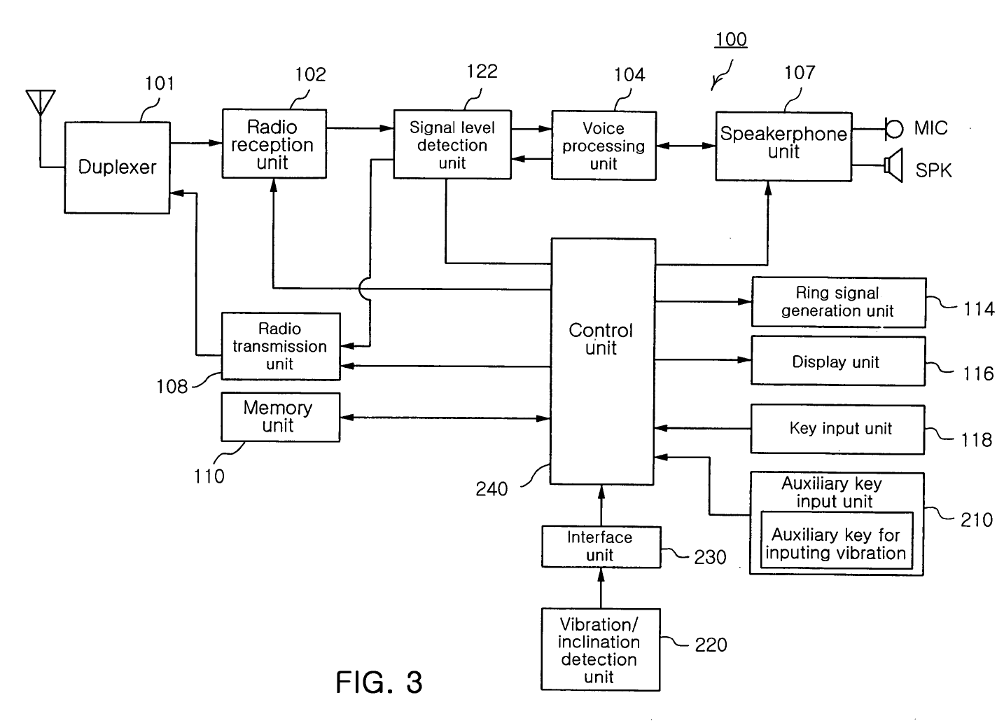

FIG. 3 is a block diagram showing the construction of the mobile phone that allows a user to input a phone number without manipulating buttons according to the present invention.

Referring to FIG. 3, the mobile phone of the present invention basically includes a duplexer 101, a radio reception unit 102, a radio transmission unit 108, a signal level detection unit 122, a voice processing unit 104, a speakerphone unit 107, a memory unit 110, a ring signal generation unit 114, a display unit 116 and a key input unit 118, which function as set forth in the description of the related arts. The mobile phone of the present invention further includes an auxiliary key input unit 210 formed on the outside of the body of the mobile phone to be easily operated so as to generate an on or off signal according to the operation of a user, a vibration/inclination detection unit 220 installed inside the phone body to detect whether there are the movement and inclination of the phone body and detect the direction and number of the movements and the inclinations, an interface unit 230 adapted to convert the output signal of the vibration/inclination detection unit 220 into a signal detectable by a control unit 240 and provide the signal to the control unit 240, and the control unit 240 adapted to control the operation of the above-described units for a voice call, check whether the auxiliary key input unit 210 is turned on or off, convert the detection signal of the vibration/inclination detection unit 220, which has been input through the interface unit 230, into a number according to a predetermined rule when an on signal is applied from the auxiliary key input unit 210, and attempt a call connection through the converted number.

The functions of the units shown in FIG. 3 are described in detail below. The duplexer 101 outputs a radio signal, which has been received from an antenna, to a radio reception unit 102, and functions to transmit a transmission signal, which has been output from a radio transmission unit 108, through the antenna. The radio reception unit 102 outputs data to a control unit 240 at the time of receiving the data, and outputs a voice signal to a voice processing unit 104. Additionally, the radio transmission unit 108 outputs a transmission signal, which has been applied from the voice processing unit 104, to the duplexer 101 through a set channel under the control of the control unit 240 at the time of calling. The voice processing unit 104 decodes the signal received from the radio reception unit 102 and outputs the decoded signal to the speaker SPK, through a speakerphone unit 107. Additionally, the voice processing unit 104 receives the user's voice, which has been converted into an electric signal by the microphone MIC, thorough the speakerphone 107, encodes the electric signal, and outputs the encoded signal to the radio transmission unit 108. Thereafter, a signal level detection unit 122 detects the intensity of a voice signal received from a transmitting terminal and the intensity of the voice signal of the user of a receiving terminal, and informs the control unit 240 of detection results. A ring signal generation unit 114 generates a ringtone under the control of the control unit 240 at the time of receiving a ring signal. A memory unit 110 includes a ROM for storing control data required for the control operation of the control unit 240, a nonvolatile memory for storing data to be stored or removed by the manipulation of the user, such as phone numbers and schedules, and a RAM for temporarily storing data generated at the time of controlling a program.

The mobile phone constructed as described above allows a user to input a phone number using two methods. A first method is the same as the conventional method that allows the user to input the phone number of a counterpart, who is desired to answer a call, by manipulating the buttons of the key input unit 118 that is exposed when a flip or folder is opened.

A second method is constructed to allow the user to input a phone number without manipulating the buttons of the key input unit 118. The execution of the second method is described below.

First, the user of the mobile phone turns on the auxiliary key input unit 210. Thereafter, the user inclines or moves the body of the mobile phone in a specific direction. The inclination and movement (vibration) of the phone body are detected by the vibration/inclination detection unit 220, and certain detection signals (e.g., a voltage of 5 V) are output from the vibration/inclination detection unit 220. The interface unit 230 converts the detection signals, which have been output from the vibration/inclination detection unit 220, into signals detectable by the control unit 240 (e.g., digital signal), and applies the converted signals to the control unit 240. Thereafter, the control unit 240 receives the converted detection signals from the interface unit 230, detects the directions and numbers of movements and inclinations, and calculates input numbers from the detected directions and numbers according to a predetermined rule while the auxiliary key input unit 210 is turned on. Furthermore, the control unit 240 attempts a call connection through the calculated input numbers when the auxiliary key input unit 210 is turned off.

In this case, the auxiliary key input unit 210 is implemented using a push button. The turning-on or turn-off of the auxiliary key input unit 210 can be set in such a way that a state in which the push button is pressed is set to a turned-on state and other states are set to a turned-off state, or a turned-off state is changed to a turned-on state if the push button is pressed for a certain time (e.g., one second) and the turned-on state is changed into the turned-off state if the push button is pressed for a certain time (e.g., one second).

The vibration/inclination detection unit 220 can be implemented using a multi-axes geomagnetic sensor or accelerometer capable of detecting earth magnetism or acceleration in two or more directions, which is located inside the phone body and adapted to detect and output the movement of the mobile phone.

Additionally, the vibration/inclination detection unit 220 can be implemented to detect only movement and inclination within a range, for example, from an angle of 45° to 90° with respect to a reference axis, as detection values.

Additionally, the rule of converting the detection signals into successive numbers, which is applied to the control unit 240, can be established in various ways, but it is preferable to set the rule in the easiest way in which people can easily understand and operate. For example, basically, there is a way of applying the numbers of detected movements and inclinations to input numbers. For the modification of the above case, there are a way of setting different numbers according to the directions of the movements and inclinations and setting input numbers to values, obtained by multiplying the numbers of the detected movements and inclinations by the set numbers, and a way of establishing a number input rule according to the sequence of movements/vibrations.

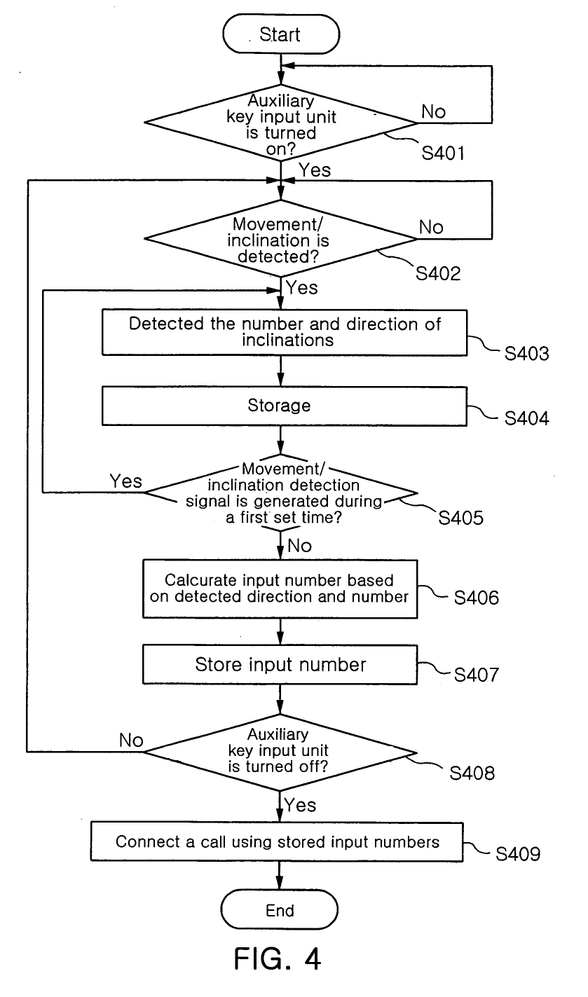

FIG. 4 is a flowchart showing a method of inputting a phone number without manipulating buttons according to the present invention.

Referring to the flowchart of FIG. 4, the control unit 240 checks whether the auxiliary key input unit 210, which is an auxiliary key for inputting vibration, is turned on or off at step S401.

If the auxiliary key input unit 210 is turned on, it is checked whether movement and inclination are detected at step S402. This can be performed by determining whether the detection signal of the vibration/inclination detection unit 220 is input.

If the detection signal of the vibration/inclination detection unit 220 is input through the interface unit 230, the direction and number of detected movements and inclinations are determined from the input detection signal at step S403. As described above, the control unit 240 stores the direction and number of the detected movements and inclinations determined from the detection signal, which has been input through the interface unit 230, while the auxiliary key input unit 210 is turned on at step S404.

In this case, for the successive input of a phone number composed of a combination of a plurality of numbers, the interval between the input of successive digits is set to a predetermined time interval (e.g., three seconds), and the predetermined time interval is referred to as a first set time.

Additionally, it is checked whether some other detection signal of the movement and inclination is input during the first set time. If there is no input of some other detection signal of the detected movement and inclination during the first set time, the input number is calculated depending on the currently stored detection data and according to the predetermined rule at step S406.

In the above description, the most basic way of calculating the input numbers is to set the input numbers into the numbers of the detected movements and inclinations. The basic way is inconvenient in that the user needs to shake or move the phone body ten times to input the number zero. To solve the inconvenience, certain multiples a, b, c and d are set on the directions of the movements and inclinations (e.g., ±x, ±y and ±z directions) for example, an upward direction is set to the number zero, a downward direction is set to the number one, a left direction is set to the number two and a right direction is set to the number three,-and values, obtained by multiplying the numbers of detected movements and inclinations in directions by set multiples, are output as input numbers. In this case, the phone body should be moved in an upward direction one time to input the number zero, and moved in a left direction one time and moved in a right direction three times to input the number five.

When the input number is calculated as described above, the calculated number is stored at step S407.

While the auxiliary key input unit 210 is turned on, steps S402 to S407 are repeated, and successive numbers having at least two digits are calculated and stored.

Furthermore, when the state of the auxiliary key input unit 210 is changed from a turned-on state to a turned-off state, the mobile phone attempts a call connection using the stored successive numbers as the phone number of a counterpart at step S409. In this case, such a method of inputting the phone number can be combined with the function of an abbreviated dialing, so that the call connection can be accomplished using a phone number registered as a corresponding input abbreviated dialing number. In this case, a speedy dialing can be accomplished.

As described above, the mobile phone of the present invention performs an automatic call connection without manipulating a small keypad and opening a flip or folder by detecting the movements of the body of the mobile phone as a number, thus providing the user with convenience. Furthermore, the mobile phone of the present invention provides an excellent effect in that an indisposed person or a person with gloves on can easily dial.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mobile phone capable of input of phone number without manipulating buttons, comprising:
vibration/inclination detection means for detecting numbers and directions of movements of a body of the mobile phone;
interface means for converting detection signals of the vibration/inclination detection means into signals detectable by control means and transmitting the signals to the control means;
auxiliary input means for generating an on or off signal according to an operation of the user, the auxiliary input means being placed on an outside of the mobile phone to be easily manipulated; and
the control means for receiving the numbers and directions detected by the vibration/inclination detection means, converting the received numbers and directions into successive input numbers according to a predetermined rule, and attempting a call connection using the converted input numbers.

2. The mobile phone as set forth in claim 1, wherein the vibration/inclination detection means is a multi-axes geomagnetic sensor or accelerometer capable of detecting earth magnetism or acceleration in two or more directions.

3. The mobile phone as set forth in claim 1, wherein the control means sets different multiples in directions of movements and inclinations, and sets input numbers to values, obtained by multiplying the numbers input through the interface means by set multiples in corresponding directions.

4. A method of inputting a phone number to a mobile phone having a vibration/inclination detection means for detecting movements of a body of the mobile phone and an auxiliary input means placed on an outside of the phone body to allow a user to turn on or off the auxiliary input means, comprising the steps of:
checking whether the auxiliary input means is turned on or off;
receiving detection signals of the vibration/inclination detection means while the auxiliary input means is turned on, and detecting and storing a number and direction of movements and inclinations of the mobile phone;
detecting a state in which there is no movement of the mobile phone during a first set time by counting successive time for which the detection signal is not output from the vibration/inclination detection means and checking whether the successive time reach the first set time;
calculating and storing the stored direction and number of the movements and inclinations to an input number according to the predetermined rule if, as a result of the detection, there is no movement of the mobile phone during the set time; and
checking whether the auxiliary input means is turned on, and repeating the above-described steps while the auxiliary input means is turned on, and attempting a call connection using stored successive input numbers if the auxiliary input means is turned off.

5. The method as set forth in claim 4, further comprising the steps of:
setting multiples a, b, c and d (in this case, a, b, c and d are integral numbers equal to or larger than zero, and a≠b≠c≠d is satisfied) on directions of the detected movements and inclinations; and
outputting values, obtained by multiplying the stored detection numbers by the set multiples (a, b, c or d) set on the corresponding directions, as the successive input numbers.
